(19) United States
(12) Patent Application Publication
(10) Pub. No.: US 2022/0139604 A1
(43) Pub. Date: May 5, 2022

(54) CAGE CORE INDUCTOR

(71) Applicant: KKM KRAFTKVALITÉMÄTNING AB, SUNDSVALL (SE)

(72) Inventor: Agne FÄLLDIN, Sundsvall (SE)

(21) Appl. No.: 17/431,556

(22) PCT Filed: Feb. 18, 2020
(86) PCT No.: PCT/SE2020/050187

§ 371 Date: Aug. 17, 2021

(30) Foreign Application Priority Data
Feb. 21, 2019 (SE) 1950225-1

(51) Int. Cl. H01F 27/02; H01F 27/32; H01F 37/00; H01F 38/18

(52) U.S. Cl. CPC H01F 27/022; H01F 38/18; H01F 37/005; H01F 27/327

(57) ABSTRACT

Described is, among other things, a cage inductor. The cage inductor can be variable and have sub coils cast in an insulating material.

### TECHNICAL FIELD

The present disclosure relates to a cage inductor. In particular, the cage inductor is suitable for use in high voltage systems.

### BACKGROUND

Inductors are a component widely used in electrical networks. It can for example be used to generate reactive power. The inductor can be designed in different ways. For example, an inductor can have an iron core or the inductor can be made with an air-core. When used to generate reactive power the inductor can typically be referred to as a reactor. Typical applications include voltages of several kV such as 10 Kv, 20 kV or 40 kV or above.

Reactors are inductive devices used in high voltage power transmission, distribution and industrial applications. These reactors are typically placed in outdoor environments. Smaller applications are also used in microelectronics as an example connected in circuit board.

An air-core inductor can be formed with a toroidal shape, see e.g. Leites, L. V. A coreless toroidal reactor for power systems', Elektrichestvo, 1960, 11, pp. 556-568.

Further, a toroidal air-core inductor can be formed as a toroidal cage inductor. A toroidal cage is made by assembling six identical sub coils. They are joined together in a well-defined way so that the complete structure looks like a six turns toroid. Each sub coil is wound separately on a special former using a coil machine. This is described in more detail in the Master's Thesis by D. Belahrache “Studies of air-cored toroidal inductors”, Loughborough University. https://dspace.lboro.ac.uk/2134/27492.

There is a constant desire to improve systems and components used for inductive power both in smaller and higher voltage ranges. Hence, there is a need for an improved inductor for use in power transmission systems and microelectronic components

### SUMMARY

It is an object of the present invention to provide an improved inductor.

This object and/or others are obtained by the inductors as set out in the appended claims. The inductors can advantageously be used as reactors and implemented as dry cage inductors. In other words, the cage inductors can be implemented without the use of oil or other wet material as isolation in the inductor.

In accordance with a first aspect of the present invention a cage inductor comprising at least three sub coils is provided. The inductor can be an air-core cage inductor, but can also be a cage inductor with an iron core, wherein each sub coil is cast in an insulating material. For example, six or even more sub coils can be used. Hereby the sub coils can be made easy to handle and assemble. Also, insulation between neighboring sub coils can be improved. Using cast insulation material such as a resin, each sub coil can be made as an entity easy to handle and is made more robust whereby production of a cage core is facilitated.

In accordance with one embodiment isolators are provided at a top section and/or at the bottom section of the sub-coils. Hereby the inductor can be mounted to a support with an insulation therein between. This can be particularly beneficial for high voltage solutions where the isolation can be used to isolate the windings from other metal parts.

In accordance with one embodiment the isolators are formed integral with material cast around the sub-coils. Hereby, an efficient production of sub coils with isolators can be obtained. In case the isolators are formed together with cast there is no need to provide separate connection points.

In accordance with some embodiments the wire wound on the sub-coils is non-circular such as having a square or rectangular cross-section. Hereby the sub coils can be more easily formed in a desired shape because the wire can be selected to suit the desired form of the sub coil. In particular it can be made easier to form a sub coil with a triangular cross section where the triangle has the desired dimensions. An additional advantage is that the sub coils can be obtained without making the wire too thick, which would make the wire less easy to bend.

In accordance with some embodiments each sub-coil is located on a plate. Hereby a good support can be provided for the inductor. Each sub-coil can additionally or alternatively be hung in a plate. Also, isolators can be provided between a sub coil and a corresponding plate. In accordance with some embodiments at least one and preferably all plates is/are grounded. Hereby particle discharges can be reduced or eliminated.

In accordance with some embodiments, the sub coils are displaceable in relation to each other. Hereby the inductance of the inductor can be varied.

In accordance with a second aspect of the invention a cage inductor comprising at least three sub coils is provided wherein the sub coils are displaceable in relation to each other. Hereby the inductance of the inductor can be varied.

In accordance with some embodiments, the cage is toroidal shaped. Hereby an efficient shape that is easy to displace the sub coils is obtained.

In accordance with some embodiments, the sub coils are D-shaped. Hereby an efficient shape for the sub coils can be obtained.

In accordance with some embodiments, the cross section of the sub coils can be made essentially triangular. For example, the coils of the sub coils can be wound in a pyramid form. Hereby the sub coils can be made to fit better at the center of the inductor formed by the sub coils.

In accordance with some embodiments the sub coils are displaceable in a radial direction from each other to increase a space in the center of the inductor. Hereby an efficient mechanism for varying the inductance of the inductor can be obtained.

In accordance with some embodiments, the sub coils are displaceable in an axial direction. Hereby an alternative and/or supplemental displacement mechanism for displacing the sub-coils can be obtained.

In accordance with some embodiments sub coils are connected to each other via a cable with at least 100 strands. Hereby a robust connector to be used for displaceable sub-coils can be formed.

In accordance with some embodiments the sub coils are configured to be displaced in response to a control signal. Hereby the inductor can be used in real time application where there is need for a variable inductance since the sub-coils can displaced in response to a control signal. The control signal can signal the need for a changed inductance. In response a control system can actuate a displacement arrangement that moves the sub coils in relation to each other.

In accordance with a third aspect of the invention, a system comprising a cage inductor is provided. The system can be configured to generate a control signal to control the displacement of the sub-coils of the inductor. Hereby efficient control of a variable inductor as in accordance with the above can be obtained.

I accordance with a fourth aspect of the invention, a cage inductor comprising at least three sub coils is provided. The wire wound on the sub-coils has a non-circular cross-section. Hereby the sub coils can be more easily formed in a desired shape because the wire can be selected to suit the desired form of the sub coil. In particular it can be made easier to form a sub coil with a triangular cross section where the triangle has the desired dimensions. An additional advantage is that can be obtained without making the wire too thick, which would make the wire less easy to bend. For example, the wire wound on the sub-coils can have a square or rectangular cross-section.

In accordance with some embodiments, the cross section of the sub coils is made essentially triangular. For example, the coils of the sub coils can be wound in a pyramid form. Hereby the sub coils can be made to fit better at the center of the inductor formed by the sub coils.

### BRIEF DESCRIPTION OF THE DRAWINGS

The present invention will now be described in more detail by way of non-limiting examples and with reference to the accompanying drawings, in which:

FIG. 1a is a view illustrating a sub coil wound in a pyramid shape for an air-core cage inductor,

FIG. 1b is a view illustrating a sub coil wound in a pyramid shape for a cage inductor with an iron core,

FIG. 2 is a cross sectional view of an air-core cage inductor,

FIG. 3a and FIG. 3b illustrate a sub coil cast in an insulating material,

FIG. 4 illustrate a sub coil when placed in a support,

FIG. 5 illustrate the use of a non-circular wire,

FIG. 6a-6 c illustrate different displacements of sub coils,

FIGS. 7a-7b illustrate a connector for connecting different sub-coils,

FIG. 8 illustrate a displacement mechanism for displacing sub coils,

FIG. 9 illustrate a control system for controlling variable inductors, in particular variable air-core cage inductors, and

FIGS. 10a-10b, illustrate another embodiment of a displaceable air-core cage inductor.

FIGS. 11a-11b illustrate an exemplary implementation of a sub-coil.

### DETAILED DESCRIPTION

In the following different embodiments of an air-core inductor will be described. The described inductors are of a so-called cage type. An air-core inductor of cage type or air-core cage inductor is in accordance with the teachings herein an inductor formed by a number, at least three, separately wounded sub-coils joined together to form a closed loop where the magnetic field can be contained substantially inside the closed loop. The loop can typically be circular in which case the air-core cage inductor will have a toroidal shape as in the Master's Thesis by D. Belahrache above. However, it is also envisaged that the loop can be oval or form some other closed loop. Further, while the cage inductors herein are mostly exemplified by air-core cage inductors, it is also envisaged that iron cores can be used in some implementations. When an iron core is used the core of each sub-coil comprises iron. For example, transformer steel can typically be used. In the figures, the same reference numerals designate identical or corresponding elements throughout the several figures. It will be appreciated that these figures are for illustration only and are not in any way restricting the scope of the invention. Also, it is possible to combine features from different described embodiments to meet specific implementation needs.

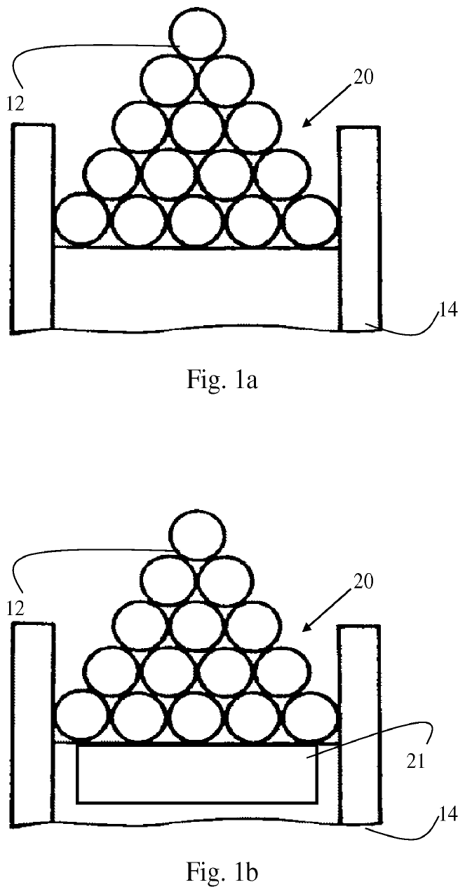

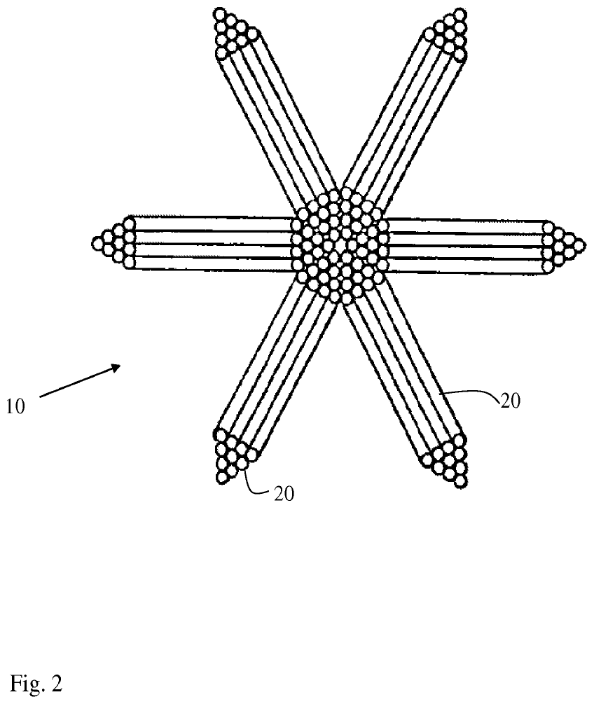

As is described in detail in the Master's Thesis by D. Belahrache cited above, it is possible to form an air-core cage inductor from six separately wound sub coils. The sub coils 10 can advantageously be wound in a pyramid form as is shown in FIG. 1a. In FIG. 1a enameled copper wire or some other insulated wire 12 is wound on a former 14 into a suitable shape such as a D-shape. The shape can be determined by designing the former 14 accordingly. For example, circular or oval shapes can be used. The number of turns of wire for each sub-coil is a design parameter. Hereby the air-core cage inductor can be made small and efficient in that the center legs of each sub coil can come very close the each other as is shown in FIG. 2 which is a cross sectional view of an air-core cage inductor 10 having six sub-coils 20 with each sub-coil wound with a pyramid form as shown in FIG. 1a.

As has been realized, it is not necessary to use six sub-coils to form an air core cage inductor, but any number of sub-coils 20 can be used as long as the magnetic field can be contained inside the inductor 10 and the magnetic field outside is below some pre-determined threshold value. This can be achieved when combining at least three sub-coils. Also, the sub-coils do not need to be positioned in a ring formation, but can be placed in any loop formation such as in an oval shape.

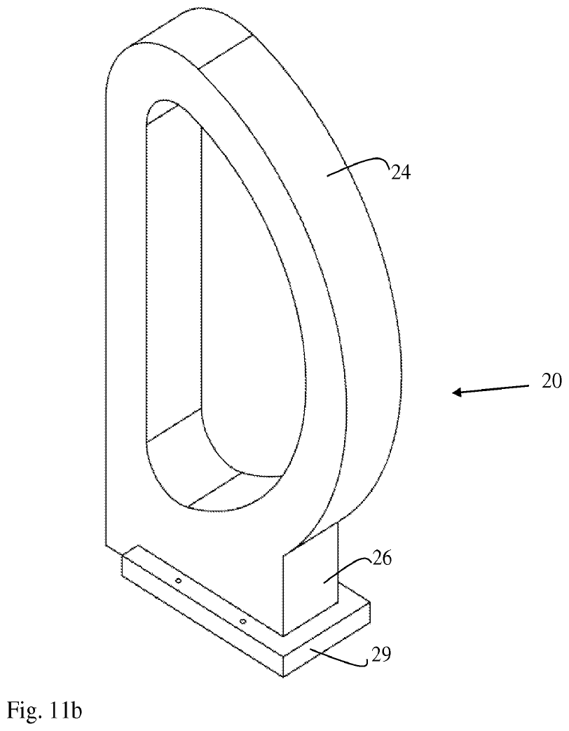

As has been further realized it can be advantageous to use a cage core inductor with an iron core instead of an air-core for some implementations. The iron core can for example be implemented using transformer steel. In FIG. 1b, which is similar to FIG. 1a an iron core 21 is used in the sub-coil 20. Thus, inside the sub coil 20 there can be air or iron structure 21. In case the sub coil 20 assembly contains iron structure 21, it can be cast in an isolating material such as resin. For example, the sub-coil of FIGS. 11a-11b ban be used.

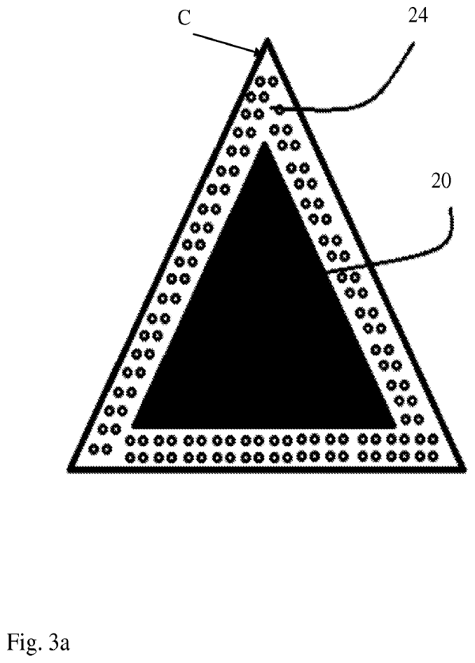

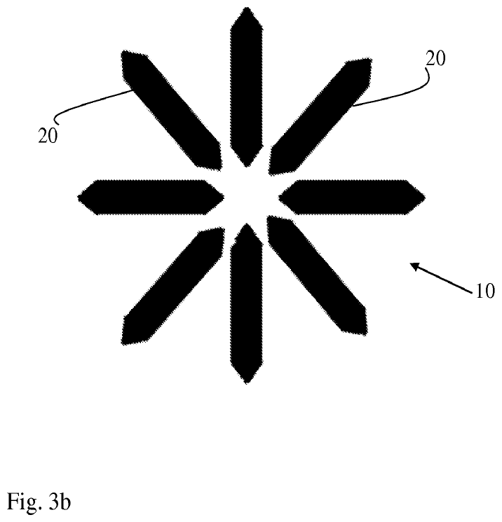

In order to obtain an efficient air core inductor, each sub coil 20 can be cast in an insulating material 24, as is shown in FIG. 3a. For example, each sub-coil 20 can be cast in an epoxy material or in cast resin. The cast around the sub-coil 20 can advantageously be air-free. This can be obtained by performing the casting in vacuum. The cast 24 around the sub-coils can be formed to make assembly of the air-core cage inductor easy. In particular the cast can be made to form “pieces of a cake” that when put together will form the complete loop of sub-coils. For example, a few mm of insulation material can be cast around a sub coil 20. The center angle of each sector like portion can correspond to the number of sub-coils used. For example, if six sub-coils are used there will be a 60-degree center angle C or if 4 sub-coils are used there will be a 90-degree center angle C. If 8 sub coils are used the center angle will be 45 degrees. The provision of a cast around the sub coils 20 thus can make it possible to assemble the inductor 10 by piecing the casts together. In addition, the provision of the insulating cast around the sub-coil will provide a double insulation between adjacent assembled sub-coils 20, which is advantageous in terms of performance of the inductor.

In FIG. 3b a top view of an implementation of an air core cage inductor 10 with 8 sub coils 20 is depicted.

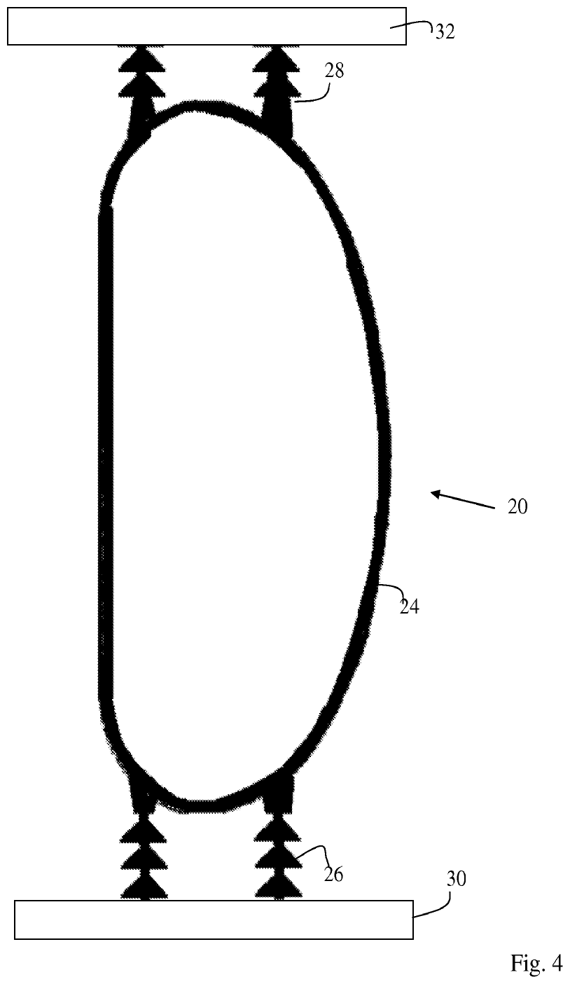

In accordance with some embodiments, isolators can be provided at a top section and/or at the bottom section of the sub-coils 20. This is shown in FIG. 4a. In FIG. 4 a first isolator 26 is provided at the bottom section of a sub coil 20. A second isolator 28 can be provided a top section of such a sub coil 20. The isolator(s) 26, 28 can in accordance with some embodiments be cast together with the cast 24. Hereby a single casting can provide for the provision of both the insulating cast around the sub coils and any isolators connected to the sub-coils 20. Thus, the isolators 26,28 can be formed integral with material cast around the sub-coils 20.

The sub coils 20 as described herein can in accordance with some embodiments be placed on a plate 30. In accordance with some embodiments the sub-coil 20 cat be attached to or hung in a plate 32. The isolators 26, 28 can then be provided between a sub coil and a corresponding plate 30, 32. A plate 30, 32 can be grounded. In some embodiments all plates 30, 32 of an air-core cage inductor are grounded. This can be advantageous because particle discharge from the inductor can then be reduced.

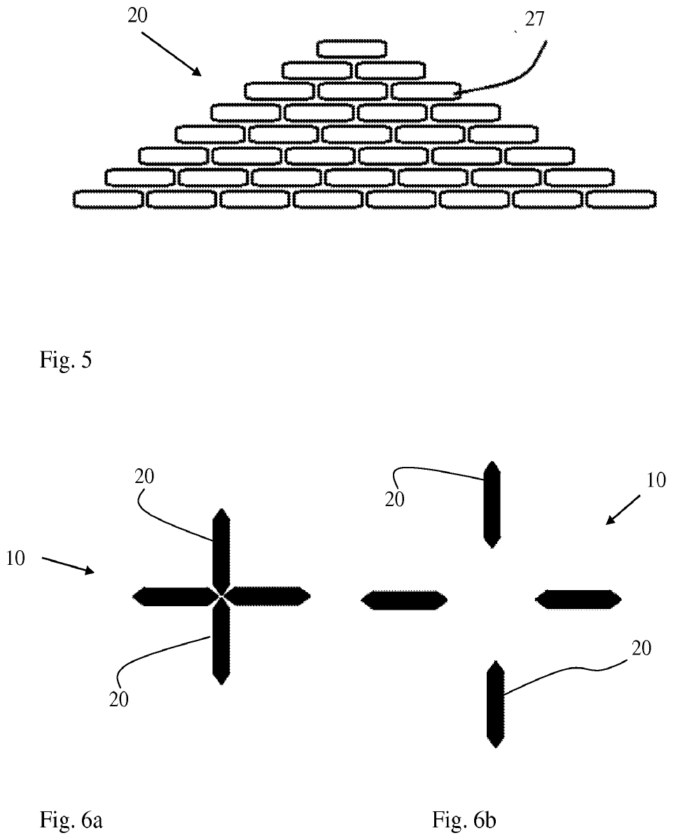

In accordance with some embodiments the wire wound to form the sub-coils can have non-circular cross section. In particular wire with a square or rectangular cross-section can be used. Hereby the shaping of the sub coils can be made easier since there is more freedom to select the shape of the wire. In particular when forming a pyramid form of the windings the use of a non-circular wire can be advantageous. In FIG. 5 a sub-coil 20 wound with rectangular wire 27 is shown. As can be seen the shape of the pyramid can be adjusted by selecting a wire that has a suitable dimension. In the pyramid form of FIG. 5 an inner layer has more wires 27 than an outer layer. In particular an or each outer layer can have one parallel wire 27 less than the layer underneath. Also, the wire can be more easily bent if the wire has a cross-section that is rectangular since the wire can be made thinner in the direction being bent without reducing the total cross-section of the wire. Generally, by using a wire with non-circular cross section, such as having a rectangular cross section, it is possible to wind the sub coils with any triangular cross section where the triangle can have suitable dimensions. For example, if the top angle of the triangular cross-section should be 45 degrees or 90 degrees or some other value, this can be easily obtained by using a wire with a rectangular cross section or an approximation of a rectangular cross section such as a wire having an oval cross-section.

In accordance with some embodiment the wire is rolled into a sub-coil. Hereby a roll can be used to apply the required force to bend the wire to its desired form.

In accordance with some implementations an air-core cage inductor can be made to have a variable inductance. This can be obtained by providing a mechanism/arrangement whereby the sub coils are displaceable in relation to each other. Thus, when the sub coils 20 of an air-core cage inductor as described herein are placed close together with their central legs close to each other a high inductance can be obtained. If, however, there is a need to vary the inductance to a lower inductance, this can be achieved by displacing the sub coils in relation to each other. In accordance with some embodiments the sub coils can be configured to be a displaceable in a radial direction from each other to increase a space in the center of the air core cage inductor. This can reduce the inductance since the inductance is typically inversely proportional to the radius of the inductor.

In accordance with some implementations the inductance L can be calculated using the expression:

L=μ⁰*(N²*A)/2pi*r

Where μ⁰ is a constant, N is the number of turns of the wire, A is the air area in the sub-coils, and r is a variable proportional to the radius of the cage inductor. Hence, the inductance will be reduced when the radius increases.

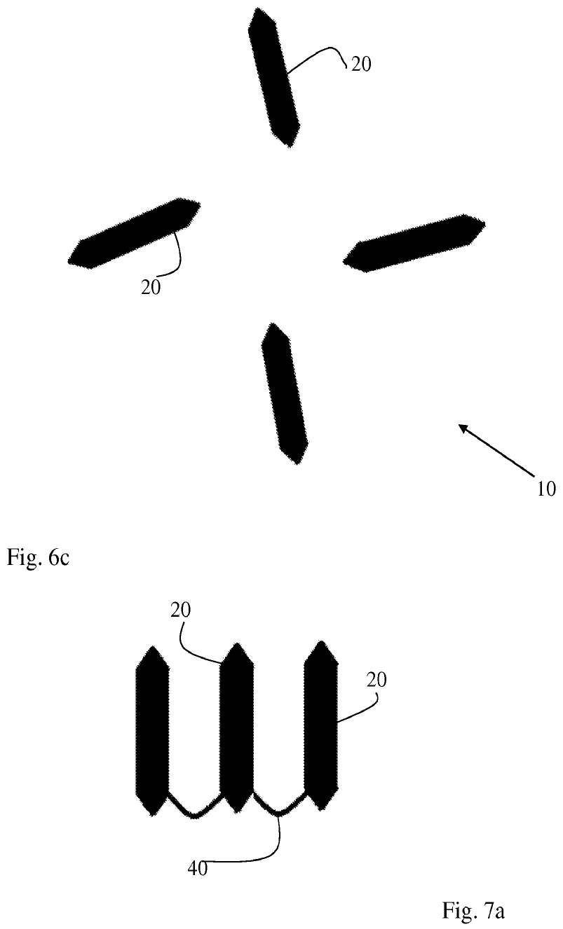

In FIG. 6a an air-core cage inductor 10 with four sub coils 20 is depicted. In FIG. 6b the sub-coils 20 have been radially displaced thereby reducing the inductance of the air-core cage inductor 10. This will to increase a space in the center of the air core cage inductor 10 thereby increasing the radius of the air core cage inductor 10.

It is also possible to adjust the inductance by other displacements of the sub-coils in relation to each other. For example, the sub-coils can be axially displaced. In FIG. 6c the sub coils are shown axially displaced. Hereby a further reduction of the inductance can be obtained.

When the sub-coils are displaceable in relation to each other, the connection between two sub-coils should typically not be fixed, but allow for the coils to move in relation to each other.

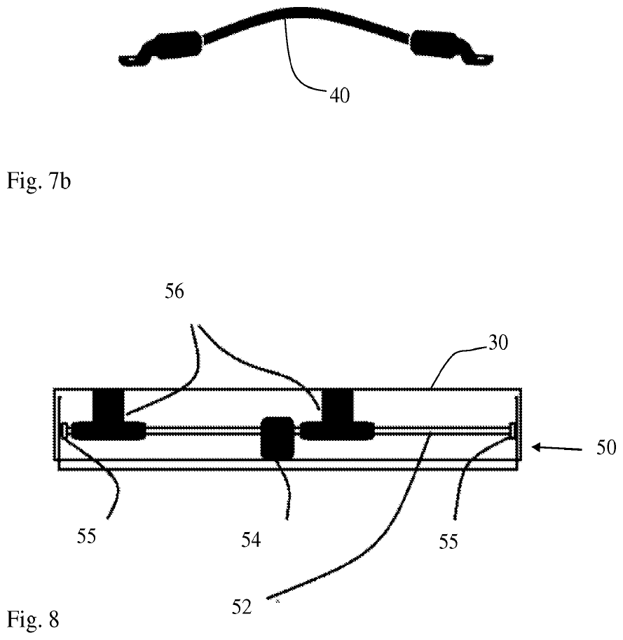

In FIG. 7a, connectors 40 connecting different sub coils 20 are shown provided in a manner to allow for displacement between the sub coils 20. In FIG. 7b a connector 40 is shown. The connector 40 can comprise many thin strands of for example copper. This will allow for a high current to flow in the connector and at the same time there is low risk of wearing on the connector 40 due to movement of the sub-coils. The connector 40 can in accordance with some embodiment be a stranded cable with many strands. For example, at least 25 strands can be used or in some implementations even 100 strands or more such as at least 250 strands can be used.

To displace the sub-coils 20 of an air-core cage inductor 10, any suitable displacement mechanism can be used. In accordance with some embodiments the sub coils 20 are placed on and/or hanging in plates as shown above in FIG. 4. In such an implantation the plates can be configured to be displaceable thereby enabling displacement of the sub coils 20. The displacement can be hand driven or in some implementations motor driven. In FIG. 8, a mechanism for displacing plates 30 are shown. The mechanism can comprise a drive mechanism 50 The drive mechanism can for example be a threaded shaft 52 driven by a rotating nut 54. The plate can be connected to the shaft and driven be the rotating threaded shaft. Bearings 55 can be provided at each end of the rotating shaft. The plate 30 can be moved by nuts 56 connected to the rotating shaft 52. In another implementation a rack is provided to move the plate 30 in a suitable direction.

In implementations where the inductance can be varied, the air-core cage inductor as described herein can be used as a control component in for example electrical power grids and other implementations where there is a need for varying the inductance. Further, as has been realized when the inductance needs to be varied in a wide range, it can be advantageous to use many sub coils, such as at least 8 or at least 12 sub coils in the air-core cage inductor. This is because when the sub coils are displaced from each other, there will be a position where the magnetic field will no longer be sufficiently contained inside the air-core cage inductor and a magnetic field with an undesired magnitude above some threshold value will be formed at a position outside the air-core cage inductor. If many sub coils are used this will occur at a larger radius of the air-core cage inductor when the sub coils are displaced radially. In other words, a larger displacement is possible when using many sub-coils without suffering from an undesired magnetic field leakage.

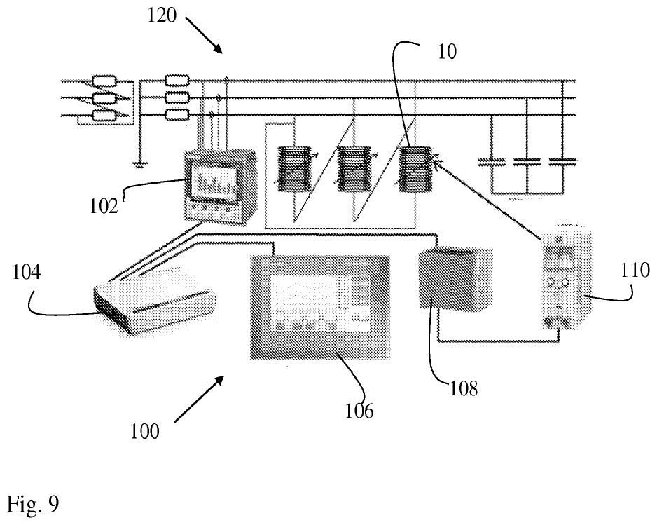

In FIG. 9, a system for controlling the inductance in a power distribution system is depicted. The system 100 comprises a power supply network 120 with variable inductors 10 in accordance with the above. The system comprises a sensor 102 for sensing the Cos fi of the system, i.e. the reactive power in the system. The measured value can be sent using a transmission network 104 to a control center 106 and also to a controller 108. Based on the received value and a target value for the reactive power of the system the controller 108 can issue a control signal to an actuator such as a motor or motor controller 110 to adjust the inductance of an inductor 10. Hence the sub coils 20 can be configured to be displaced in response to the control signal.

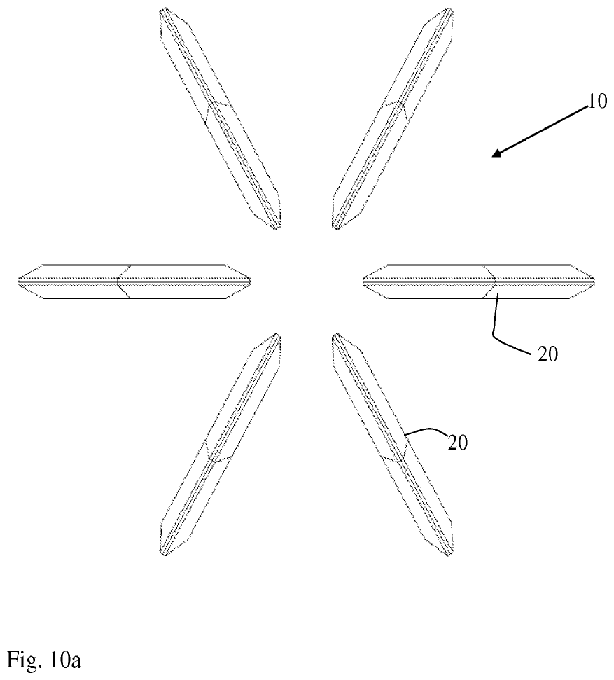

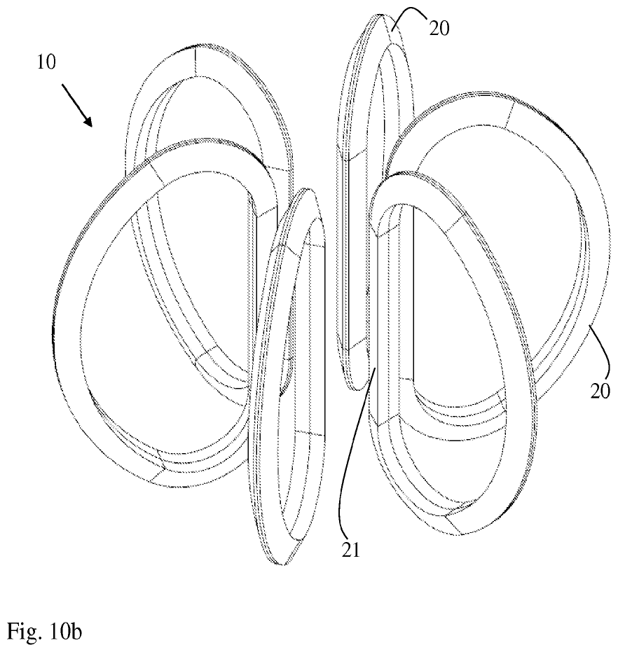

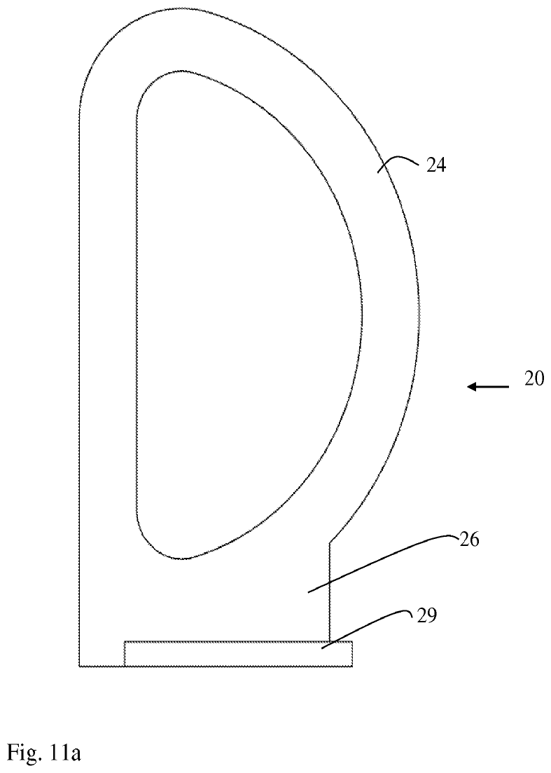

In FIG. 10a yet another embodiment of an air-core cage inductor 10 is shown in a top view. The air-core cage inductor of FIG. 10 has six sub coils 20. The sub-coils are shown in a position with the sub coils 20 in a position where the sub coils have been radially displaced from a centralized position. Hence the inductance will be reduced compared to when the inner legs of the sub coils are closer together. In FIG. 10b a perspective view of the air-core cage inductor of FIG. 10a is shown. As can be seen the sub coils 20 are D-shaped with the long leg 21 facing the center part of the air-core cage inductor. D-shaped sub-coils can be advantageous in many implementations, but other forms of the sub-coils can be used when required or advantageous for a particular implementation.

In FIG. 11a, an exemplary implementation of a sub-coil 20 is depicted as a side view. The sub-coil can in some embodiments have an iron core. The sub-coil is formed as solid sub coil structure cast in an isolating material 24, such as a resin. The isolating material 24 provides the sub-coil 20 (here D shaped) with isolation. Also, the isolation material 24 can provide an isolating support structure. The isolating support structure can be used as the isolator(s) 26, 28 as described above. The isolation can bet hick enough for providing a sufficient degree of isolation. For example, for a 11 kV cage inductor, 3 mm of isolation can be used. For a higher voltage cage core more isolation can be added to provide sufficient isolation for safe handling of the cage inductor. For example, 5 mm of isolation can be provided for a 22 kV cage inductor. In order to make each sub-coil easy to handle during assembly of the cage core inductor and also for handling the assembled cage inductor it can be beneficial to use the isolator material 24 as a support structure for the sub-coils. Additional isolating material is then typically required. Typically, at least 8-10 mm (or more) of isolating material can be used. Hereby the sub-coil can be rigid and easy to handle. In other words, more isolating material than required for isolation is used to also create a support structure in the sub-coil. This has the benefit that the support structure is manufactured in the same processing step as applying isolation. In addition, support 29 such as a metal support can be attached to the sub-coil for facilitating assembly of the sub-coil 20 to a complete reactor.

In FIG. 11b, the exemplary sub-coil 20 of FIG. 11a is shown in perspective.

The cage inductors as described herein can be used in many different applications. Both applications where a fixed inductance is required, but also where a variable inductance is required can use some of the air-core inductors described. One typical application can be as a reactor. Reactors are applied in a variety of different ways within transmission and distribution systems. As such they provide various application related benefits such as enhancing network reliability and safety, extending equipment life, increasing transmission capacity, and improving system efficiency through the reduction of losses.

Some examples of application for the cage inductor as described herein are for Current Limiting, Power Flow Control, Capacitor Switching, Harmonic Filtering, Reactive Power Compensation and HVDC Smoothing.

The cage inductor as described herein can be made easy to assemble and disassemble in that the sub-coils can be cast in suitable shapes. This type if inductor produced in accordance with the teachings herein, with air or iron core structure, provides large scale of usability from small sizes to large units including the possibility easily vary the inductance and have small magnetic field outside the inductor structure.

The cage inductors can be implemented as dry inductors meaning that there is no need for oil insulation in the winding structure of the inductor.

1. A cage inductor comprising at least three sub coils, wherein each sub coil is cast in an insulating material.

2. Cage inductor according to claim 1, wherein isolators are provided at a top section and/or at the bottom section of the sub-coils.

3. Cage inductor according to claim 2, wherein the isolators are formed integral with material cast around the sub-coils.

4. Cage inductor according to claim 1, wherein the wire wound on the sub-coils has a non-circular cross-section.

5. Cage inductor according to claim 4, wherein the wire has a rectangular cross-section.

6. Cage inductor according to claim 1, wherein each sub-coil is located on a plate.

7. Cage inductor according to claim 1, wherein each sub-coil is hung in a plate.

8. Cage inductor according to claim 6, wherein isolators are provided between a sub coil and a corresponding plate.

9. Cage inductor according to claim 6, wherein at least one plate is grounded.

10. Cage inductor according to claim 1, wherein the sub coils are displaceable in relation to each other.

11. Cage inductor according to claim 1, wherein the core of each sub coil is made of air.

12. Cage inductor according to claim 1, wherein the core of each sub coil is made of a material comprising iron.

13. Cage inductor according to claim 1, wherein the isolation material is at least 8-10 mm thick.

14. Cage inductor comprising at least three sub coils, wherein the sub coils are displaceable in relation to each other.

15. Cage inductor according to claim 14, wherein the cage is toroidal shaped.

16. Cage inductor according to claim 14, wherein the sub coils are D-shaped.

17. Cage inductor according to claim 14, wherein the coils of the sub coils have a triangular cross section.

18. Cage inductor according to claim 14, wherein the sub coils are displaceable in a radial direction from each other.

19. Cage inductor according to claim 14, wherein the sub coils are displaceable in an axial direction.

20. Cage inductor according to claim 14, wherein the sub coils are connected to each other via a cable with at least 100 strands.

21. Cage inductor according to claim 14, wherein the sub coils are configured to be displaced in response to a control signal.

22. System comprising a cage inductor according to claim 14, wherein the system is configured to generate a control signal to control the displacement of the sub-coils of the cage inductor.

23. Cage inductor comprising at least three sub coils, wherein the wire wound on the sub-coils has a non-circular cross-section.

24. Cage inductor according to claim 23, wherein the wire wound on the sub-coils has a rectangular cross-section.

25. Cage inductor according to claim 23, wherein the sub coils have a triangular cross section.
